(19) United States
(12) Patent Application Publication
(10) Pub. No.: US 2019/0227184 A1
(43) Pub. Date: Jul. 25, 2019

(54) GAUGE LENGTH OPTIMIZATION FOR SIGNAL PRESERVATION AND GAUGE LENGTH PROCESSING FOR DISTRIBUTED VIBRATION SENSING

(71) Applicant: Schlumberger Technology Corporation, Sugar Land, TX (US)

(72) Inventors: Theo Cuny, Clamart (FR); Ali Ozbek, Cambridge (GB); Arthur Hartog, Cambridge (GB)

(21) Appl. No.: 15/876,712

(22) Filed: Jan. 22, 2018

(51) Int. Cl. G01V 1/16; G01D 5/28; G01V 1/52

(52) U.S. Cl. CPC G01V 1/162; G01V 1/168; G01V 1/52; G01D 5/28

(57) ABSTRACT

Techniques are disclosed that facilitate use of a distributed vibration sensing system for collecting data in a well application to provide improved collection of strain related data, such as for a seismic survey. The techniques facilitate selection of a variable optimal gauge length that optimally preserves the signal bandwidth and temporal resolution of the sensing system and that can be tuned using the actual apparent velocity and maximum recoverable frequency of the monitored parameters. Techniques for real-time processing of DVS data using a preliminary variable optimal gauge length are disclosed, as well as techniques for re-processing the DVS data at a later time using an updated variable optimal gauge length that is derived from the preliminary processing of the DVS data.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, additional information on the formation and borehole may be obtained by using a wireline tool, i.e., a tool conveyed in the well via a wireline cable, in order to prepare production, to know more accurately the formation or to make sure the well is consolidated. After that, various forms of well completion components may be installed in the well in order to control and enhance the efficiency of producing the various fluids from the reservoir. Information from the wells can prove valuable, but reliably obtaining useful information from the well can be difficult.

One manner in which information can be obtained from a well is to use a distributed fiber optic sensing system, such as a distributed vibration or acoustic sensing system. The sensing system may be for instance permanently installed as part as the well completion components or may be lowered in the well with the wireline tool, as part of the wireline cable. More generally, the sensing system may be lowered in the wellbore on any type of conveyance (slickline, coiled tubing, etc.) or component. Fiber optic sensors employ the fact that environmental effects, such as pressure, strain, vibration, and temperature, can alter the amplitude, phase, frequency, spectral content, or polarization of light propagated through an optical fiber. Advantages of fiber optic sensors include their light weight, small size, passive nature, energy efficiency, and ruggedness. In addition, fiber optic sensors have the potential for very high sensitivity, and wide bandwidth. Yet further, certain classes of sensors can be distributed along the length of an optical fiber so that an appropriate interrogation system can be employed to monitor selected environmental parameters at continuous locations at the same time. For instance, when deployed in a hydrocarbon well, a fiber optic sensor can provide indications of characteristics of production fluids, such as temperature, fluid composition, density, viscosity, flow rate, etc. Or the sensor can provide information indicative of the operational state of downhole components, such as by monitoring vibration in the region proximate the components. Yet further, the sensor can provide information about characteristics of the earth formation penetrated by the well, such as be monitoring seismic events.

### BRIEF DESCRIPTION OF THE DRAWINGS

Certain embodiments of the invention are described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current invention.

FIG. 1 is a schematic representation of an example of a well system that includes a distributed vibration sensing (hereinafter “DVS”) system, according to an embodiment.

FIG. 2 is a schematic representation of an example of a control system that can be used in conjunction with the DVS system of FIG. 1, according to an embodiment.

FIG. 3. is a graphical illustration of criteria selected to define variable optimal gauge length values, according to an embodiment.

FIG. 4 is a graphical illustration of an exemplary relationship between a variable optimal gauge length determined using the criteria of FIG. 3 and the input lowest wavelength, according to an embodiment.

FIG. 5 is an exemplary workflow for generating DVS differentiated phase data using a fixed gauge length.

FIG. 6 is an exemplary workflow for generating DVS differentiated phase data using a variable optimal gauge length profile, according to an embodiment.

FIG. 7 is an exemplary workflow for real-time processing of DVS data using a preliminary variable optimal gauge length profile, according to an embodiment.

FIG. 8 is another exemplary workflow for re-processing the DVS data using a new variable optimal gauge length profile that is created based on the preliminary processing of the DVS data pursuant to the workflow of FIG. 7, according to an embodiment.

### SUMMARY

Certain embodiments of the present disclosure are directed to a method for use in a well that includes deploying an optical fiber along well equipment and positioning the equipment in a wellbore that penetrates a region of interest. The optical fiber is connected into a distributed vibration sensing system, and a length of the fiber is used to detect signal indication of vibration in the region of interest. A wavelength of interest of the signals to be detected is selected as a function of the length of the optical fiber to create a variable gauge length profile. The profile has gauge length values to apply to phase data acquired from the detected signals. The values vary as a function of the optical fiber length. The variable gauge length profile is used to process the phase data acquired from the optical fiber, where a gauge length value associated with a particular section of the optical fiber is used to process the phase data acquired from that particular section.

Embodiments also are directed to a method that includes deploying a distributed vibration sensing system to detect dynamic strain incident along the length of an optical fiber. The method also includes creating a variable gauge length profile to generate optimal gauge length values tuned for corresponding sections of the optical fiber. The profile is created by selecting, for each section of the optical fiber, a lowest wavelength of the signal causing the dynamic strain experienced by that section of the optical fiber.

Embodiments also are directed to a method that includes deploying a distributed vibration sensing system to detect dynamic strain incident along a length of an optical fiber, and creating a preliminary variable gauge length profile to define preliminary optimal gauge length values tuned for corresponding sections of the optical fiber. A differentiated phase data set is generated by applying the preliminary values to optical data acquired from the optical fiber that is indicative of the detected dynamic strain.

### DETAILED DESCRIPTION

In the following description, numerous details are set forth to provide an understanding of the present disclosure. However, it will be understood by those skilled in the art that the embodiments of the present disclosure may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention.

The present disclosure generally relates to systems and methods that facilitate use of a distributed vibration sensing system for collecting data. For example, the distributed vibration sensing system may be employed in a well application to provide improved collection of strain related data, such as for a seismic survey. To that end, techniques described herein facilitate selection of a desired gauge length that optimally preserves the signal bandwidth and temporal resolution of the sensing system and that can be tuned using the apparent velocity and maximum recoverable frequency of the monitored parameters. The optimal gauge length can vary according to specific factors, e.g., depth within a well, velocity and bandwidth, and the present technique accounts for such factors in the selection of a gauge length that optimizes the collection of data.

The present disclosure also introduces a technique for processing the data collected by the distributed vibration system which allows for the gauge length to change along the optical fiber so that the gauge length can be optimized locally rather than representing a global compromise that is used regardless of the location along the entire sensing fiber. In addition, multiple techniques for processing the distributed vibration data are disclosed that provide for an improved data set at the wellsite and/or during reprocessing, e.g., in the geophysicist's office or other location remote from the wellsite.

In general, fiber optic monitoring systems, particularly distributed fiber-optic monitoring systems, employ an optical source (e.g., a laser) to generate pulses of optical energy to launch into an optical fiber that is deployed in a region of interest (e.g., in a wellbore). As the launched pulses travel along the length of the optical fiber, small imperfections in the fiber reflect a portion of the pulses, generating backscatter. When the fiber is subjected to strain (such as from vibration or acoustic signals propagating through the region of interest), the distances between the imperfections change. Consequently, the backscattered light also changes. By monitoring the changes in the backscatter light generated by the fiber in response to interrogating pulses, it is possible to determine the dynamic strain, or vibration, experienced by the fiber. The measured strain or vibration can then be used to derive information about the parameters of interest, such as characteristics of a surrounding earth formation.

One type of fiber optic monitoring system is referred to as a Distributed Vibration Sensing (DVS) system or, alternatively, a Distributed Acoustic Sensing (DAS) system. For convenience, both DVS and DAS systems are generally referred to herein as a DVS system. DVS systems have been used to efficiently gather seismic data in applications such a pipeline security monitoring and vertical seismic profiling. DVS systems also have been deployed to monitor fluid flow in subterranean wellbores.

In DVS systems, a narrowband laser is generally used as an optical source to generate interrogating pulses of light to launch into the sensing fiber. The use of a narrowband laser results in interference between backscatter returned from different parts of the fiber that are occupied by a probe pulse at any one time. This is a form of multi-path interference and gives rise to a speckle-like signal in one dimension (along the axis of the fiber), sometimes referred to as coherent Rayleigh noise or coherent backscatter. The term “phase-OTDR (optical time domain reflectometry)” also is used in this context. The interference modulates both the intensity and the phase of the backscattered light and minute (<<wavelength) changes in the length of a section of fiber are sufficient to radically alter the value of the amplitude and phase. Consequently, the technique can be useful for detecting small changes in strain.

However the local amplitude (proportional to the square root of the intensity) or the phase, which may be measured locally with respect to specific locations on the sensing fiber, has a strongly non-linear relationship to the applied strain. In contrast, measurement of the phase-difference across a length of fiber results in a more linear transfer function between strain and the phase-difference and is therefore chosen as an indicator for detecting changes in strain. The phase difference may be measured in the electrical or digital domains by mixing the backscattered light with a local oscillator which converts the scattered light, including its phase, down to a frequency that can be captured electronically. The phase-difference may then be calculated in the digital domain or by an analog phase-measuring circuit prior to digitization.

In another example, the phase of the scattered light returning from two separate locations can be compared in the optical domain with a phase-sensing interferometer which includes a delay-line fiber that results in the mixing at the detector of the backscattered light returning from two separate locations in the fiber. Another approach is to launch pairs of probe pulses separated by a defined frequency and launching time, thus resulting in two sets of backscatter signals at different frequencies that combine at the detector to form a beat frequency. The backscatter signals arriving at the detector have been scattered from slightly different locations in the fiber that are separated by ΔL=ΔT*c/(2*Ng), where “ΔT” is the time separation of the probe pulses, “c” is the speed of light in vacuum, and “Ng” is the group index of the fiber. Another approach is to modulate the phase of one of a pair of pulses such that the phase of the second pulse, relative to that of the first is varied in a pre-defined way on each repetition of the pulse sequence (for example the relative phase of the pulses is shifted by a quarter of a cycle between repetitions of the pulse sequence). Regardless of how the phase is acquired, these differential phase techniques involve comparing the phase at two locations in the fiber separated by what is sometimes known as the “gauge length” or “differentiation interval.”

Techniques for selecting a gauge length (also referred to herein as “GL”) to achieve an optimal tradeoff between the spatial resolution of a DVS system and the signal-to-noise ratio (SNR) in a borehole seismic surveying application are disclosed in International Publication No. WO 2016/112147 A1, published Jul. 14, 2016. In accordance with those techniques, a gauge length is selected using Equation 1 below:

$$GL = ratio \times \frac{{V}_{min}}{{f}_{dom}} \qquad ( 1 )$$

where “Vₘᵢₙ” is the minimum wave velocity of the monitored parameter, e.g., a seismic wave; and “f_{dom}” is the dominant frequency of the monitored parameter. In the embodiments disclosed, the input wavelength is defined as

$$\frac{{V}_{min}}{{f}_{dom}}$$

and is a wavelength of interest of the seismic wave. In particular, “ratio” is in a range between 0.3 to 0.6 so that SNR is superior to a target value and the difference between output (measured) and input wavelength is inferior to another target value. Generally, GL is selected as 0.6 times the input wavelength in applications where the SNR is the primary consideration (and spatial resolution is deemed not to be important or less important).

Although the use of Equation 1 to select a desired GL does indeed provide an improvement in SNR, in some applications, it can also present too great of a compromise with respect to the signal bandwidth and thus can potentially affect the reliability of time picking of the data.

Accordingly, embodiments disclosed herein are directed to selection of a desired GL that preserves the SNR as in the prior art while also protecting the signal bandwidth.

Another potential drawback of selecting a GL in accordance with Equation 1 is that it results in use of a single GL for the entire dataset, therefore restricting its definition to be tied to the minimum apparent wave velocity and the dominant frequency. However, in embodiments involving borehole seismic surveying where the velocity of the seismic wave varies with depth, selection of a single GL may not be optimal for all sections of the sensing fiber. For example, if the GL is selected to be optimal for the bottom section of the fiber, the GL may be sub-optimal for the top section because of the different wave velocities. This can result in over-smoothing of the data for the top section of the fiber because the GL is too long, or under-smoothing if the GL is too short, and thus may have a detrimental impact on the quality of the acquired data when velocity of the seismic waves varies over the different sections of the wellbore.

Accordingly, embodiments disclosed herein are directed to a processing approach where the optimal GL is varied along the length of the fiber, thus facilitating selection of a local optimal GL based on an actual local wave velocity and frequency. This approach improves locally the SNR and preserves the signal, rather than selecting a GL based on a global compromise. Techniques for processing a DVS data set in real time (e.g., at the wellsite) and/or at a later time (e.g., remote from the wellsite) using a selected optimal GL that varies along the length of the fiber also are disclosed.

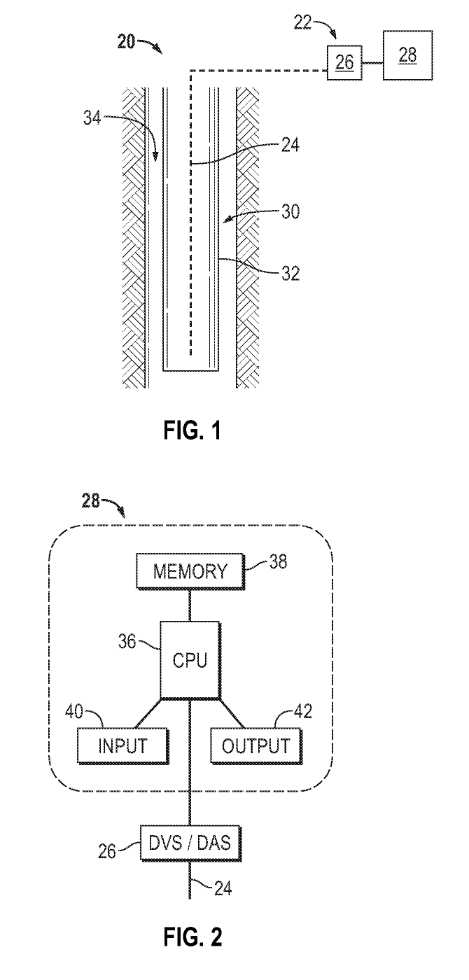

Referring now to FIG. 1, an example of a well system 20 comprising a DVS system 22 is illustrated. In this embodiment, the DVS system 22 comprises an optical fiber 24 used to obtain data, e.g., strain data. The optical fiber 24 can be in the form of a cable and can be coupled with an interrogation unit 26. For some applications, the interrogation unit 26 includes a detector for monitoring backscatter signals. Additionally, the interrogation unit 26 can comprise a suitable optical source, e.g., a narrowband laser, to establish interference between backscatter signals returned from different parts of the fiber 24. For example, the interrogation unit 26 can be used to provide a probe signal sent along fiber 24 via the laser. The interrogation unit 26 also can be part of or coupled with a processor-based control system 28 used to process the collected data.

In the specific example illustrated in FIG. 1, the fiber 24 is deployed along well equipment 30. By way of example, the well equipment 30 may comprise a well string 32, e.g., a tubing string, and the fiber 24 may be secured along the well string 32. Depending on the application, the fiber 24 can be adhered to or otherwise affixed to the well string 32 so as to facilitate monitoring of strains experienced due to vibrations from seismic waves, fluid flow, and/or other sources. In another example (not shown in FIG. 1), the well equipment can include a wireline tool and a wireline cable for conveying the wireline tool, and the fiber can be bundled to the wireline cable. As illustrated, the well string 32 can be deployed in a wellbore 34 although the DVS system 22 can be employed in other well applications and in non-well applications.

The data obtained by DVS system 22 can be processed according to various methods as described above. Additionally, the data can be processed in whole or in part on processor-based control system 28. An example of the processing system 28 is illustrated in FIG. 2 and can be in the form of a computer-based system having a processor 36, e.g., a central processing unit (CPU). The processor 36 can be operatively employed to intake data from fiber 24/interrogation unit 26 and to process the data. Depending on the application, the processing of data may involve the running of various models/algorithms related to evaluation of signal data, e.g., backscatter data, received from the sensing fiber 24. By way of example, the data can be processed to determine suitable values, e.g., optimal values, of gauge lengths for the DVS system 22 for corresponding sections of the fiber 24, as will be described in greater detail with reference to the various equations and workflows set out below.

The processor 36 can be operatively coupled with a memory 38, an input device 40, and an output device 42. Input device 40 can comprise a variety of devices, such as a keyboard, mouse, voice recognition unit, touchscreen, other input devices, or combinations of such devices. Output device 42 can comprise a visual and/or audio output device, such as a computer display, monitor, or other display medium having a graphical user interface. Additionally, the processing can be done on a single device or multiple devices on location, away from the well location, or with some devices on location and other devices located remotely. Once the desired signal processing has been conducted to evaluate the vibrations/strains for determining the desired gauge length values, the processed data, results, analysis, and/or recommendations can be displayed on output 42 and/or stored in memory 38.

In embodiments disclosed herein, the criteria that were selected to define optimality of the gauge length are based on data preservation and on metrics which have a clear meaning for the geophysicist and other users of the DVS system. In selecting the criteria, the optical pre-processing of the DVS data set was generally assumed to be non-linear.

To determine the criteria for optimality, a Klauder Wavelet model was used in order to control both the velocity of the arrival of the seismic wave, and its bandwidth (low and high frequency). After generating a simple geophysical synthetic, it was fed into a mathematical model of the DVS physics to produce a synthetic optical signal, that was then fed into a standard optical processing algorithm. Because the GL is one of the parameters of this processing, the impact of the GL on the data could be studied while varying the geophysical parameters of the model.

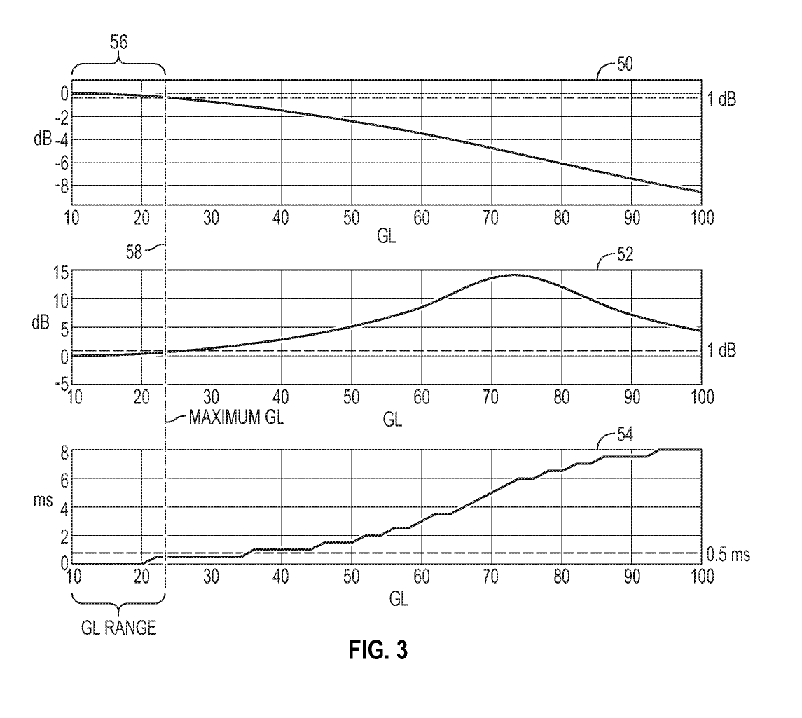

Using that approach, the effect of the GL on the output DVS dataset was studied and compared with the geophysical model. This resulted in the definition of three criteria for selecting optimal GLs, which are the boost at the lowest frequency of the bandwidth (“LF Boost”) (50), the attenuation at the highest frequency (“HF Attenuation) (52), and the loss of temporal resolution of the output time wavelet compared to the input wavelet (“Resolution Loss”) (54). Graphs of examples of the three criteria 50, 52, 54 are shown in FIG. 3, where the horizontal axis in each graph represents the gauge length value. In FIG. 3, the top graph is a plot of the LF Boost 50, where the vertical axis represents boost in decibels (dB). The middle graph is a plot of the HF Attenuation 52, where the vertical axis represents attenuation in dB. The bottom graph is a plot of the Resolution Loss 54, where the vertical axis represents time in milliseconds (ms). In the examples shown, to avoid edge effects, frequencies nearby the lowest and highest limits of the bandwidth were considered (i.e., the LF Boost 50 was evaluated at 10 Hz above the minimum frequency, and the HF Attenuation 52 was evaluated at 10 Hz below the maximum frequency).

The first two criteria, i.e., the LF Boost 50 and the HF Attenuation 52, have clear meanings related to the distortion of the signal bandwidth, and how it can be controlled. The third criterion, i.e., the Resolution Loss 54, relates to the reliability (e.g., uncertainty) of the time pick of the data after optical processing, as it is important that there be no apparent time delay for a reliable checkshot processing using a DVS dataset.

Having selected the three criteria 50, 52, and 54, constraints then were applied to the criteria in order to define an optimal GL for this example. First, as shown in FIG. 3, the LF Boost 50 and HF Attenuation 52 were constrained to not be higher than 1 dB. Second, as shown in FIG. 3, the Resolution Loss 54 was constrained to be lower than 0.5 millisecond, so that the time picks will be reliable at 1 millisecond output sample rate. The criteria that are defined here are exemplary. In embodiments in which LF Boost 50, HF Attenuation 52 and Resolution Loss 54 are selected as the criteria, other target values can be selected. For example, in some applications, preservation of bandwidth may be considered more important than SNR. Thus, a lower limit on the target value for HF Attenuation 52 can be applied, such as 0.1 dB as an example. In other applications, preservation of bandwidth may be considered less important than improvement of the SNR, in which case a higher target value for HF Attenuation 52 can be selected, such as 2 dB as an example. In any case, the Resolution Loss should always remain lower than 1 ms to prevent affecting the Checkshot results.

In the example of FIG. 3, and for the particular application of interest (i.e., a seismic survey), using these three criteria and constraints results in definition of a range 56 of permissible GL values in which the optimal GL for a particular application is in the upper limit of that range (as shown by reference 58 in this example), since as the value of GL increases, the greater the SNR (up to a limit). An example of this relationship between GL and SNR can be seen in the plot of HF Attenuation 52 in FIG. 3. As shown in that example, as the value of GL increases, the HF Attenuation 52 also increases until it reaches a limit (represented by the peak at about GL=72 m in this example).

Regardless, within the permissible range 56 for the example in FIG. 3, the optimal GL is defined as the highest GL that provides (1) a maximum 1 dB boost at the lowest frequency of the bandwidth; (2) a maximum 1 dB attenuation at the highest frequency of the bandwidth; and (3) a maximum 0.5 millisecond time resolution loss.

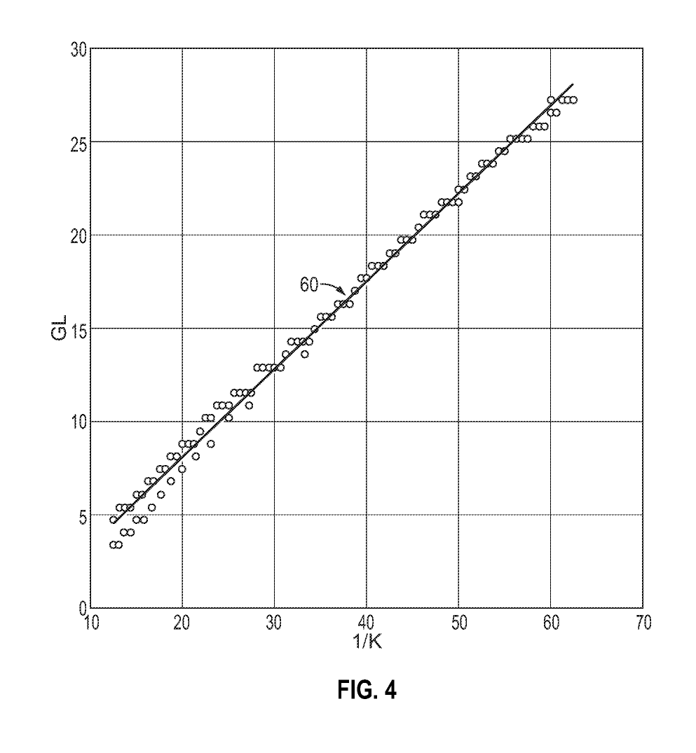

Using this definition of the optimal GL, the relationship of the GL with the parameters of the geophysical input were studied. The study revealed that the optimal GL is not sensitive to the lowest frequency of the bandwidth, and is linearly related to the velocity and the inverse highest frequency. Further analysis revealed that the optimal GL is approximately linearly related to the ratio between the wave velocity and the highest frequency, which defines the lowest wavelength. This result is shown in FIG. 4, which illustrates the approximate linear relationship between the optimal GL (vertical axis) and the lowest wavelength (horizontal axis). When a linear model is fit to the relationship shown in FIG. 4 (which corresponds to line 60 in this example), a tuning rule for the optimal GL results.

Consequently, optimum values for GL can be provided by Equation 2:

$$GL = α ( {A}_{HF} , {A}_{LF} , {T}_{FB} ) \times \frac{V}{{f}_{max}} \qquad ( 2 )$$

where “V” is the apparent velocity (local velocity) of the seismic wave, and “fₘₐₓ” is the maximum frequency of the local recoverable bandwidth. The parameter α( [symbol] _{HF}, [symbol] _{LF}, [symbol] _{FB}) represents the tuning value or multiplier that is derived from the linear relationship illustrated in FIG. 4. In this example, “α” is a function of HF Attenuation, LF Boost and Resolution Loss, and α( [symbol] _{HF}=1 dB, [symbol] _{LF}32 1 dB, [symbol] _{FB}=0.5 ms). However, it should be understood that the multiplier is determined as a function of the criteria chosen and the target values selected for those criteria and, thus, in other embodiments or applications in which the concepts disclosed herein are implemented, the range or optimal value of the multiplier “α” can differ from that shown in FIG. 4. In embodiments, the multiplier “α” range is in the range of 0 to 1. In embodiments, the value of HF Attenuation may be selected from the range of 0.1 dB to 2 dB, the value of LF Boost may be selected from the range of 0.1 to 2 dB, and the value of Resolution Loss may be selected up to 1 ms maximum, with the range of the multiplier “α” then be determined accordingly between 0.2 and 0.6 This definition of an optimal GL represented in Equation 2 above can then be applied to the processing of the DVS dataset. In embodiments, the optimal GL can be applied to the entire data set, although this can result in a global compromise on the data quality. In other embodiments, the quality of the DVS data can be improved by selecting an optimal GL that varies so that it is locally optimal along the sensing fiber.

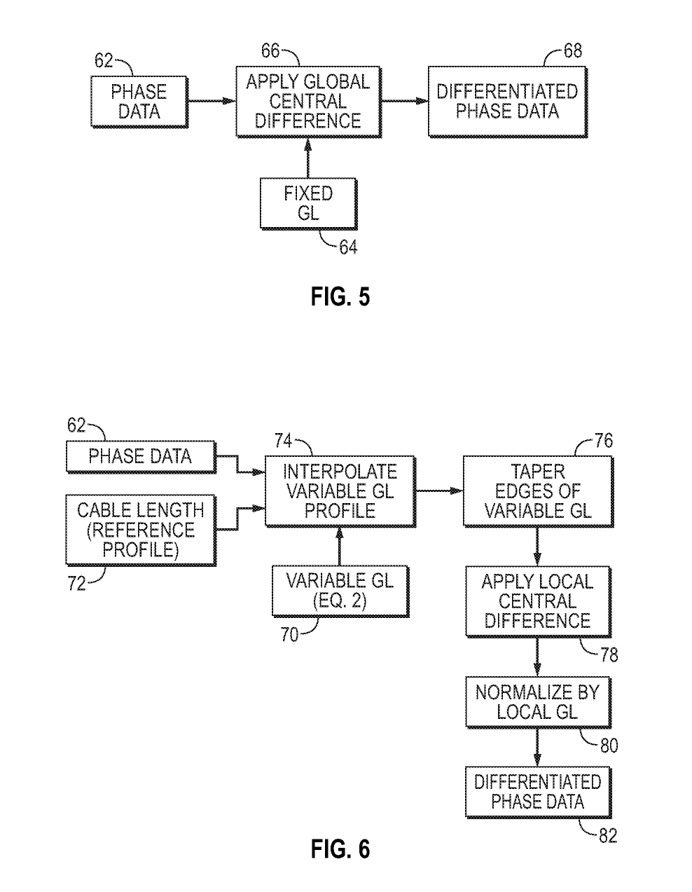

FIG. 5 is a workflow diagram showing exemplary processing of a DVS dataset in applications in which a fixed GL (as opposed to a variable GL) is used. In FIG. 5, DVS data 62, i.e., the phase data, and a fixed GL 64 are provided as inputs to a differentiation interval processing block 66 that applies a global central difference to generate differentiated phase data 68 as the output. Techniques for obtaining phase data have been discussed above. Any of those techniques or techniques of the prior art that may be known or techniques that may be developed can be employed with the workflow of FIG. 5 to acquire the phase data to which the differentiation interval and GL then is applied to derive the differentiated phase data.

In contrast to FIG. 5, FIG. 6 is a workflow diagram showing exemplary processing of the DVS data 62 using a variable optimal GL 70 that has been selected in accordance with Equation 2. As shown in FIG. 6, the differentiation interval processing block 66 is replaced so that a variable value for the optimal GL (block 70) is used for the differentiation interval, where the variable value is controlled by a reference profile that is defined by the cable length (block 72), i.e., the length of the sensing fiber. In general, the reference profile provides a correlation between depth and a sensing location along the fiber. As such, use of the cable length as a reference profile can help to avoid difficulties with depth calibration or changes in the output depth spacing. The reference profile that is associated with the variable GL profile is used to assign a depth to the GL values in the variable GL profile and thereby helps to define which local value of the GL should be applied to a particular depth section of the phase data given that the phase data may be recorded or processed with its own independent depth spacing, recording interval, etc. At processing block 74, the phase data 62, cable length (or reference profile) 72 and the variable optimal GL 70 are provided as inputs to interpolate a variable GL profile which is adapted to the recording or playback parameters of the phase data. At processing block 76, the variable GL profile is modified to ensure a linear taper at the beginning and end to avoid edge effects and to be able to process all the data points in the data set. Processing block 78 maintains a local zero-phase output (as in block 66 of FIG. 5), but uses the variable GL profile as an input rather than a fixed GL. At block 80, the data then is normalized locally by the GL to avoid variable amplitude issues and preserve the output unit. The output of the workflow is a differentiated phase data set 82.

When the inventors applied the processing workflow of FIG. 6 to a real DVS dataset, the result was visually very close to the conventional velocity data. No clear distortion in the output data could be discerned, which had an improved SNR compared to using a fixed small GL for the entire dataset, thus validating the use of Equation 2 and the workflow of FIG. 6 to define a variable optimal GL.

The concepts embodied in Equation 2 and the workflow of FIG. 6 can be used to process the DVS data in real-time at the wellsite and/or to reprocess the DVS data at a later time, such as at a location remote from the wellsite (e.g., the geophysicist's office). With respect to real-time processing, in various embodiments, Equation 2 and the workflow of FIG. 6 can be used to estimate a preliminary GL and a preliminary GL profile during a planning stage, e.g., before the seismic survey is conducted, based on previous data or assumptions about the wellsite and the surrounding geology and the seismic source. The estimates can then be used for real-time processing of the DVS data at the wellsite in order to improve the quality of the acquired data set. However, if historical data is not available for the estimation, then the DVS data can be processed at the well site using a preliminary GL that is selected by a user, e.g., the geophysicist, or that is determined in other manners, e.g., as disclosed in International Publication No. WO 2016/112147 A1, published Jul. 14, 2016, discussed above. Regardless of the GL selected for real-time processing, the DVS data from the wellsite can then later be reprocessed using the variable optimal GL defined by Equation 2 and the workflow of FIG. 6 in order to produce an updated (or further updated) DVS data set. In embodiments, the updated or further updated DVS data set have an improved quality.

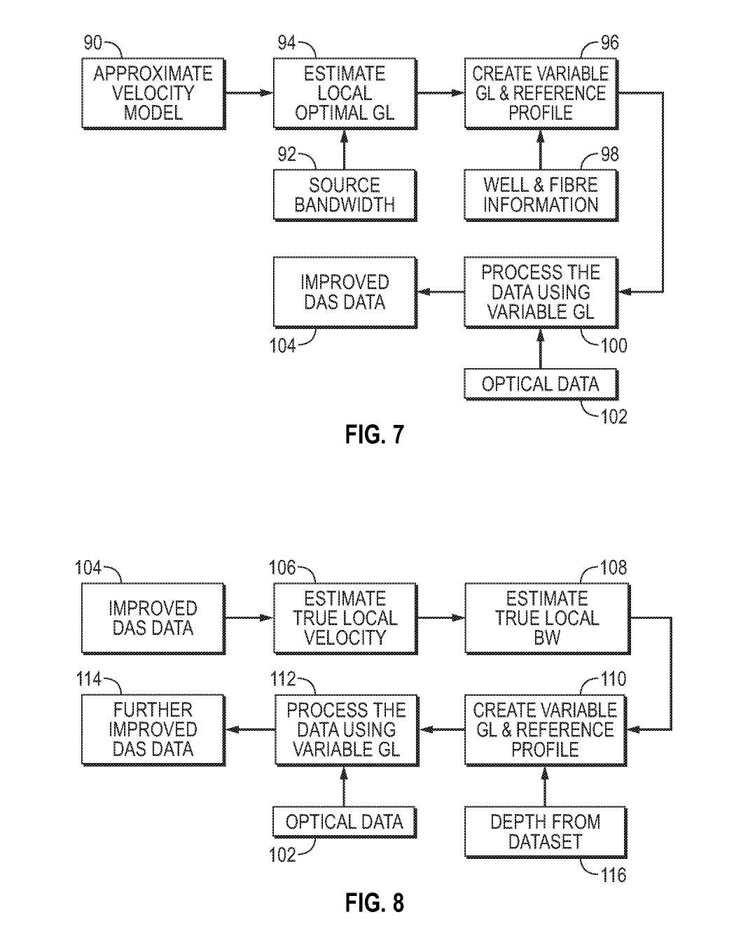

As an example, estimation of a preliminary GL can be done at the planning stage of a seismic survey. At this stage, a geophysicist typically plans the acquisition using an approximate velocity model of the seismic signals, such as a simple blocked velocity model or velocity information previously obtained from nearby wells or logs. Similarly, at this stage, the bandwidth of the seismic source that will be used for the seismic survey is known and therefore can be used as a preliminary approximation of the recoverable bandwidth in the DVS dataset. The approximate velocity model and the seismic source bandwidth thus can be used as inputs during the job planning phase to derive a variable GL profile that contains a first approximation of the local optimal GL, using Equation 2. At this stage, characteristics of the well and sensing fiber deployment also typically are known and, if so, can be used to derive the associated reference profile. As illustrated in the example workflow of FIG. 7, the variable GL profile and the reference profile can then be used during the real-time processing of the optical data during the survey to provide improved results at the wellsite.

With reference to the example of FIG. 7, an approximate velocity model 90 and a seismic source bandwidth 92 are provided as inputs to a processing block 94 to estimate a local optimal gauge length. In embodiments described herein, the local optimal gauge length is determined by applying Equation 2, where “V” corresponds to the velocity model 90 and “fmax” corresponds to the source bandwidth 92. The estimated optimal gauge length is then provided as in input to a processing block 96, along with information 98 that is relevant to the well and the sensing fiber which is indicative of the length over which the reference profile will be defined, e.g., the location of the end of the fiber such as in a permanent survey application, the planned winch depth for a wireline survey, etc. The processing block 96 uses the estimated gauge length and the well and fiber information 98 to create a variable gauge length profile and a reference profile. In processing block 100, these profiles are then used to process received optical data 102 using a variable GL in accordance with the workflow shown in FIG. 7 (e.g., blocks 76 (taper edges), 78 (apply local central difference), 80 (normalize)). The output of the block 100 is an updated DVS data set 104 that has been generated in real-time at the well site.

In embodiments, the updated DVS data set 104 then can be stored (such as in memory 38) along with the optical data 102 so that it can be reprocessed at a later time, such as at the geophysicist's office, to further update (e.g., improve) the updated DVS data set 104. This reprocessing can be based on new attributes extracted from the updated DVS data set 104. It should be understood, however, that the reprocessing can be performed on a DVS data set where the real-time processing at the well site simply applied a fixed gauge length or other gauge length that was not determined in accordance with the workflows described herein.

Regardless of how the DVS data set for reprocessing was obtained, in FIG. 8, the data set 104 can be picked and the actual local velocity can be estimated in order to yield an updated (e.g., higher quality) velocity profile that more closely corresponds to the actual conditions present during the seismic survey (block 106). Similarly, an actual local bandwidth can be estimated that takes into account local attributes present during the survey, such as ground attenuation and partial loss of the seismic source bandwidth (block 108). Using the two updated profiles, an updated local optimal GL (using Equation 2) can be determined (block 110) and then used to reprocess (block 112) the optical data 102 (again using the processing workflow (e.g., blocks 76, 78 and 80) illustrated in FIG. 7) to generate a further updated (e.g., improved) DVS data set 114. In this workflow, since the actual optical data from the wellsite is available, the actual depth 116 from the dataset can be used for the reference profile, as illustrated in FIG. 8.

The various blocks of the workflows shown in FIGS. 5-8 have been referred to as processing blocks which can be executed by a processor-based processing system, such as the system 28 shown in FIG. 2. It should be understood, however, that some functions illustrated in the processing blocks also can be performed by an operator of the system. Further, it should be understood that the workflows can include additional functionality and that various functions may be performed in different orders or in parallel. It should further be understood that well system 20, including the DVS system 22 and fiber optic cable 24, shown in FIG. 1 can utilized to acquire the optical data for processing according to the workflows shown in FIGS. 5-8. In applications in which the techniques disclosed herein are used for a seismic survey, the arrangement of FIG. 1 can further include a seismic source that is deployed, for example, at a location on the surface penetrated by the wellbore 34.

Further, in the foregoing description, data (e.g., optical data or processed DVS data) and instructions (including instructions of software for performing the workflows or parts of the workflows shown in FIGS. 5-8) are stored in appropriate storage devices (such as, but not limited to, storage device 38 in FIG. 2) which are implemented as one or more non-transitory computer-readable or machine-readable storage media. The storage devices can include different forms of memory including semiconductor memory devices; magnetic disks such as fixed, floppy and removable disks; other magnetic media including tape; optical media such as compact disks (CDs) or digital video disks (DVDs); or other types of storage devices.

Further, although the GL optimization techniques have been described in the context of a wellbore seismic profiling application, the techniques can be used in a variety of applications and environments. Moreover, when used in seismic profiling, the techniques are not limited to any particular type of seismic wave, but can be applied to compression waves, shear waves, refracted waves, etc. Further, in certain applications, multiple different types of waves may be of interest in the acquired optical data set. For example, in seismic profiling, both compression waves and shear waves may be of interest. In such applications, multiple optimal gauge length profiles can be determined for each type of wave of interest. In such embodiments, each of the optical gauge length profiles can be applied to the optical data set to thereby generate multiple output data sets, each of which has been optimized for the particular wave of interest, as an example.

While the invention has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the invention.

What is claimed is:

1. A method for use in a well, comprising:
deploying an optical fiber along well equipment;
positioning the well equipment in a wellbore that penetrates a region of interest;
connecting the optical fiber into a distributed vibration sensing system;
employing a length of the optical fiber to detect signals indicative of vibration in the region of interest;
selecting a wavelength of interest of the signals to be detected as a function of the length of the optical fiber to generate a variable gauge length profile to apply to phase data acquired from the detected signals, wherein the variable gauge length profile defines gauge length values that vary as a function of the optical fiber length; and
using the variable gauge length profile to process the phase data acquired from the length of the optical fiber, wherein a gauge length value associated with a particular section of a plurality of sections of the optical fiber is used to process the phase data acquired from the particular section to thereby generate processed phase data.

2. The method as recited in claim 1, wherein selecting the wavelength of interest comprises selecting the lowest wavelength of interest.

3. The method as recited in claim 1, wherein employing comprises using the length of the optical fiber to detect signals in the form of seismic waves propagating in the region of interest.

4. The method as recited in claim 1, wherein selecting comprises estimating an apparent velocity and a maximum frequency of the bandwidth of the signals to be detected at each of the plurality of sections of the optical fiber.

5. The method as recited in claim 4, wherein the apparent velocity is estimated based on a pre-existing velocity model and wherein the maximum frequency is estimated based on a bandwidth of a seismic source to be used to generate seismic waves in the region of interest.

6. The method as recited in claim 5, further comprising using the processed phase data to estimate an updated apparent velocity and an updated maximum frequency for each of the sections of the optical fiber and thereby generate an updated variable gauge length profile.

7. The method as recited in claim 6, further comprising applying the updated variable gauge length profile to the phase data to thereby generate updated processed phase data.

8. The method as recited in claim 6, further comprising generating a reference profile that correlates depth in the wellbore to location along the length of the optical fiber, and using the reference profile to generate the variable gauge length profile.

9. A method comprising:
deploying a distributed vibration sensing system to detect dynamic strain incident along the length of an optical fiber; and
creating a variable gauge length profile to generate optimal gauge length values tuned for corresponding sections of the optical fiber, wherein the variable gauge length profile is created by selecting, for each section of the optical fiber, a lowest wavelength of the signal causing the dynamic strain experienced by the corresponding section of the optical fiber.

10. The method as recited in claim 9, wherein the signals causing the dynamic strain are seismic waves.

11. The method as recited in claim 10, wherein the lowest wavelength for each section of the optical fiber is selected by estimating an apparent local velocity of the seismic wave experienced by that particular section of the optical fiber.

12. The method as recited in claim 10, wherein the lowest wavelength for each section of the optical fiber is selected by estimating an apparent local bandwidth of the seismic wave experienced by that particular section of the optical fiber.

13. The method as recited in claim 11, wherein the apparent local velocity is estimated based on prior knowledge of surrounding geology.

14. The method as recited in claim 12, wherein the apparent local bandwidth is estimated based on the bandwidth of a seismic source deployed to perform a seismic survey of surrounding geology.

15. The method as recited in claim 14, wherein the optical fiber is deployed in a wellbore that penetrates a region of interest in the surrounding geology.

16. The method as recited in claim 10, further comprising applying the variable gauge length profile to optical data acquired from the optical fiber that is indicative of the dynamic strain to thereby generate differentiated phase data.

17. The method as recited in claim 16, further comprising using the differentiated phase data to estimate an actual apparent local velocity and maximum frequency of the seismic waves experienced by each section of the optical fiber, and creating an updated variable gauge length profile based on the apparent local velocity and maximum frequency.

18. The method as recited in claim 17, further comprising re-processing the optical data acquired from that optical fiber by applying the updated variable gauge length profile to thereby generate updated differentiated phase data.

19. The method as recited in claim 16, further comprising:
creating a second variable gauge length profile to generate second optimal gauge length values tuned for corresponding sections of the optical fiber, wherein the second variable gauge length profile is created by selecting, for each section of the optical fiber, a second wavelength of interest of a second signal causing the dynamic strain experienced by the corresponding section of the optical fiber, wherein the variable gauge length profile is tuned for a first type of seismic wave and the second variable gauge length profile is tuned for a second type of seismic wave; and
applying the second variable gauge length profile to the optical data acquired from the optical fiber to thereby generate second differentiated phase data.

20. A method, comprising:
deploying a distributed vibration sensing system to detect dynamic strain incident along a length of an optical fiber;
creating a preliminary variable gauge length profile to define preliminary optimal gauge length values tuned for corresponding sections of the optical fiber; and
applying the preliminary optimal gauge length values to optical data acquired from the optical fiber that is indicative of the detected dynamic strain to thereby generate a differentiated phase data set.

21. The method as recited in claim 20, further comprising:
using the differentiated phase data set to create an updated variable gauge length profile; and
re-processing the optical data acquired from the optical fiber using the updated variable gauge length profile to thereby generate an updated differentiated phase data set.
